(19) United States
(12) Patent Application Publication
(10) Pub. No.: US 2012/0122554 A1
(43) Pub. Date: May 17, 2012

(54) System and method for in-game interactive advertising

(75) Inventors: Philippe Paquet, Studio City, CA (US); Amy Kalson, Burbank, CA (US)

(73) Assignee: DISNEY ENTERPRISES, INC., BURBANK, CA (US)

(21) Appl. No.: 12/927,342

(22) Filed: Nov. 12, 2010

(51) Int. Cl. A63F 9/24; A63F 13/00

(52) U.S. Cl. 463/25; 463/35

(57) ABSTRACT

Provided are systems and methods for execution by a processor of an electronic gaming device to provide in-game interactive advertising. One example method includes placing an advertisment within an electronic game environment configured for execution by the electronic gaming device, detecting when a player reaches the advertisement, notifying the player of an option to bookmark the advertisement, receiving a selected option from the player and storing the selected option in a bookmark record. Another method additionally includes communicating a bookmark in the bookmark record corresponding to the selected option to the player upon the player leaving the electronic game environment and listing an in-game reward for choosing to follow the bookmark.

### BACKGROUND OF THE INVENTION

1. Field of the Invention

The present invention relates generally to interactive advertising. More particularly, the present invention relates to interactive advertising in electronic games.

2. Background Art

Since the beginning of audio and video media, there has been media advertising. Likewise, throughout the technical development of audio and video media, there have been parallel breakthroughs in advertising that have kept advertising relevant. Although often disparaged for interrupting broadcast media experiences, for example, advertising has played an important part in funding the immense growth of media and general access to information. Thus, as media has become more interactive and the international two-way communication infrastructure has become more robust, interactive advertising has experienced pressure to keep pace.

One example of interactive media available to almost all consumers today is electronic games. Electronic games may be played on computers, game consoles, or even modern cellular phones, and as the capability of each technology has increased, the electronic games played using those technologies have become more interactive, realistic and immersive. Moreover, as each gaming device has become more interconnected with other devices and the sharing of information between devices has become more seamless, consumers have begun to use electronic games as not just a medium for entertainment, but also as a medium for communication. As a direct result, an increasing number of consumers spend a large portion of their time playing such games and playing them more often.

However, as electronic games have become more prevalent on a wide array of technological platforms, the cost of developing such games has typically increased, in part due to the costs of developing each game for multiple platforms simultaneously in order to reach as wide an audience as possible as quickly as possible. Furthermore, as more electronic games have entered the market, the return on investment with such games has become more volatile, often making it difficult to obtain funding for development.

Accordingly, there is a need to overcome the drawbacks and deficiencies in the art by providing in-game interactive advertising that can increase revenue from the use of electronic games without causing undesirable interruption of an in-game experience.

### SUMMARY OF THE INVENTION

The present application is directed to a system and method for in-game interactive advertising, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for providing in-game interactive advertising according to one embodiment of the present invention;

FIG. 2 shows a flowchart describing the steps, according to one embodiment of the present invention, by which in-game interactive advertising may be provided;

FIG. 3 presents a diagram of a system for providing in-game interactive advertising according to one embodiment of the present invention.

### DETAILED DESCRIPTION OF THE INVENTION

The present application is directed to a system and method for in-game interactive advertising. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. Unless noted otherwise, like or corresponding elements among the figures may be indicated by like or corresponding reference numerals. Moreover, the drawings and illustrations in the present application are generally not to scale, and are not intended to correspond to actual relative dimensions.

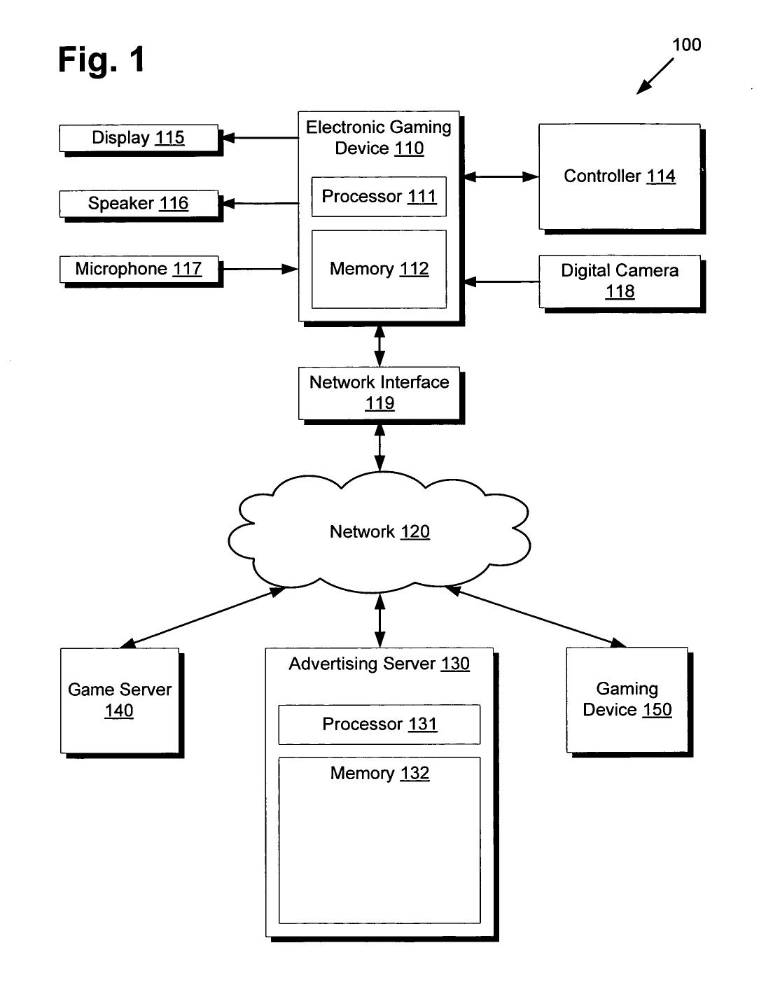

FIG. 1 presents a diagram of a system for providing in-game interactive advertising, according to one embodiment of the present invention. System 100 of FIG. 1 includes electronic gaming device 110, controller 114, display 115, speaker 116, microphone 117, digital camera 118, network interface 119, network 120, advertising server 130, game server 140 and gaming device 150. Electronic gaming device 110 includes device processor 111 and device memory 112. Similarly, advertising server 130 includes server processor 131 and server memory 132.

Electronic gaming device 110 may comprise, for example, a desktop computer, a laptop computer, a tablet computer, a videogame console, a mobile phone, or any device capable of executing an electronic game environment, communicating with a player and accepting player input. Additionally, in order to provide in-game interactive advertising, electronic gaming device 110 may also be configured to place an advertisement within an electronic game environment, detect when a player reaches the advertisement, notify the player of an option to bookmark the advertisement, and provide a means for a player to bookmark the advertisement and then access the bookmark at some later stage of the electronic game, all while executing the corresponding electronic game environment.

Generally, an electronic game environment may comprise a set of programmatic rules determining when and how to communicate portions of the electronic game environment to a player using electronic gaming device 110. Typically, such a set of programmatic rules is known in the art as a game engine, and the game engine may control game play as well as the look and feel of the game.

For example, in one embodiment, an electronic game environment may additionally comprise a database of three-dimensional shapes and images arranged and configured to represent a physical world or space in which to play a game. Such arrangement may be visually displayed or communicated to a player using display 115, for example, according to rules set forth in the associated game engine. In another embodiment, an electronic game environment may comprise a database of audible sounds, for example, that are selected and configured to reproduce an auditory environment for a player using speaker 116. In a further embodiment, an electronic game environment may comprise an amalgam of a real-life environment, an arrangement of visible images, and/or a selection of audible sounds that is used to form an augmented reality environment. For example, microphone 117 and/or digital camera 118 may be used to sample a real-life environment and electronic gaming device 110 may be used to overlay visible images and/or a selection of audible sounds over those samples to produce an augmented reality electronic game environment for the player that is configured for execution by electronic gaming device 110.

An electronic game environment configured for execution by electronic gaming device 110 may comprise a complete environment executing completely within device memory 112 of electronic gaming device 110, for example, or may comprise a subset of a larger electronic game environment executing on game server 140. Electronic gaming device 110 may access a larger electronic game environment on game server 140 by using network interface 119 and network 120 to request and/or receive different subsets of a larger gaming environment depending on circumstances within the game, for example. In one embodiment, a subset of a larger game environment may include in-game circumstances of other players also participating in the game using other gaming devices, such as gaming device 150 for example, also connected to game server 140 through network 120.

Network 120 may be any single private or public network, such as a cellular network or the Internet, for example, or any combination of private and public networks, and network interface 119 may be any interface configured to access and transmit information over such networks on behalf of electronic gaming device 110. Game server 140 may comprise one or more server computers configured to store a larger game environment and to transmit subsets of the larger game environment to and from gaming devices, like electronic gaming device 110 and gaming device 150 for example, to facilitate interaction between players, or to provide additional game functionality.

As explained above, electronic gaming device 110 may communicate with a player through visible images displayed using display 115. However, electronic gaming device 110 may also communicate with a player through audible sounds played using speaker 116, or through a combination of images and sounds, or through any other means, such as through physical motion generated by an electro-mechanical device, for example, situated in controller 114.

Controller 114 may comprise, for example, a keyboard, a mouse, a game controller, a touch-screen input, a thermal and/or electrical sensor, or any wired or wireless device or collection of devices capable of accepting player input for use within an electronic game environment and providing that input to electronic gaming device 110. Although game controller 114 is shown in FIG. 1 as separate from electronic gaming device 110, in other embodiments, game controller 114 may be integrated into electronic gaming device 110. Moreover, although microphone 117 and digital camera 118 are shown as separate from both electronic gaming device 110 and controller 114, microphone 117 and digital camera 118 may be used to accept aural or visual player input for use in an electronic game environment and, in other embodiments, may be integrated into either controller 114 or electronic gaming device 110. Likewise, although display 115, speaker 116 and network interface 119 are all shown as separate from electronic gaming device 110 in FIG. 1, in other embodiments, each component may be selectively integrated into electronic gaming device 110 in order to provide overall compactness, reduced power use, or other derivative benefits.

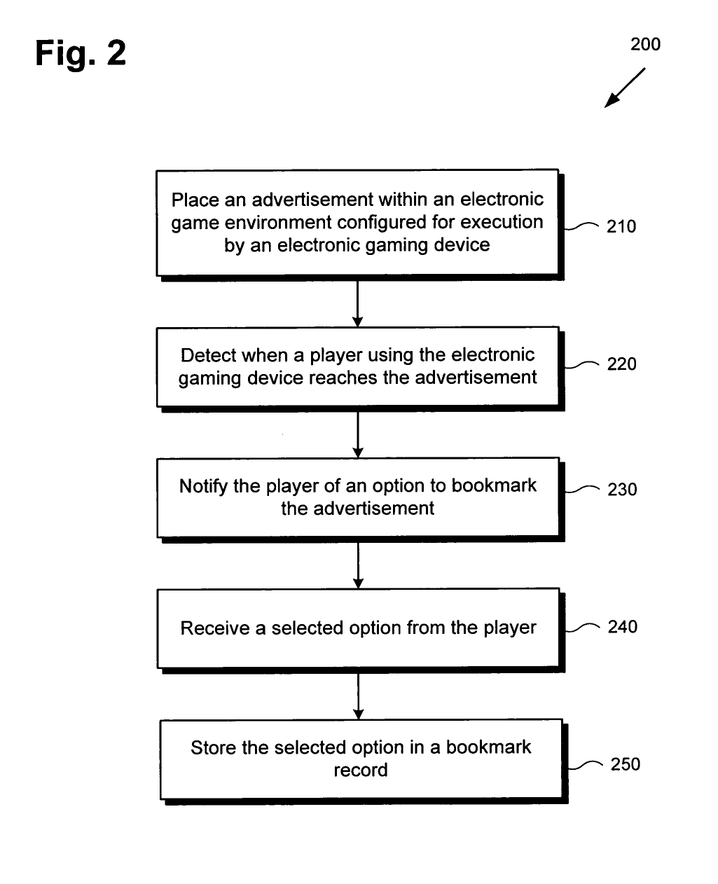

In order to provide in-game interactive advertising, according to the present inventive concepts, electronic gaming device 110 may, as outlined above, be configured to place an advertisement within an electronic game environment, detect when a player reaches the advertisement, notify the player of an option to bookmark the advertisement, and provide a means for a player to bookmark the advertisement and then access the bookmark at some later stage of the electronic game, all while executing the corresponding electronic game environment. By providing the above functionality while the electronic game environment is executing, embodiments of the present invention advantageously provide advertising without unduly interrupting game play. Detailed explanation of an embodiment of the present invention's method is provided below through explanation of steps 210 through 250 of flowchart 200 in FIG. 2 using context provided by system 100 in FIG. 1.

Moving to FIG. 2, FIG. 2 shows a flowchart 200 describing steps, according to one embodiment of the present invention, by which in-game interactive advertising may be provided. Certain details and features have been left out of flowchart 200 that are apparent to a person of ordinary skill in the art. For example, a step may comprise one or more substeps or may involve specialized equipment, materials or algorithms, as known in the art. While steps 210 through 250 indicated in flowchart 200 are sufficient to describe one embodiment of the present invention, other embodiments of the invention may utilize steps different from those shown in flowchart 200.

Referring to step 210 of flowchart 200 in FIG. 2 and system 100 of FIG. 1, step 210 of flowchart 200 comprises processor 111 of electronic gaming device 110 placing an advertisement for in-game interactive advertising within an electronic game environment configured for execution by electronic gaming device 110.

An advertisement for in-game interactive advertising may comprise, for example, programmatic rules, visible images and/or audible sounds that are configured to communicate an advertising message to a player within an electronic game environment. For example, such an advertisement may be a subset of an electronic game environment, much like an electronic game environment may be a subset of a larger electronic game environment executing on a game server, as described above.

In one embodiment, electronic gaming device 110 may place such an advertisement within an electronic gaming environment by, for example, executing an electronic game environment that already includes programmatic rules, visible images and/or audible sounds configured to communicate an advertisement to a player. When electronic gaming device 110 executes such an electronic game environment for a player, electronic gaming device 110 enables a player to use in-game play to reach the advertisement, thus placing the advertisement within the currently executing electronic game environment without unduly interrupting game play.

In other embodiments of the present invention, electronic gaming device 110 may place an advertisement within an electronic gaming environment that does not already include rules, visible images and/or audible sounds configured to communicate an advertisement to a player. Under such circumstances, and although such a step is not shown in FIG. 2, electronic gaming device 110 may first receive an advertisement from, for example, an advertising server, such as advertising server 130 in FIG. 1. Advertising server 130, in FIG. 1, may comprise one or more server computers configured to transmit advertisements to gaming devices such as electronic gaming device 110. Although advertising server is shown as separate from game server 140 in FIG. 1, in some embodiments, game server 140 and advertising server 130 may be integrated into the same server, or, alternatively, advertising server 130 may transmit advertisements to game server 140 for later transmission to gaming devices.

After receiving an advertisement from advertising server 130, electronic gaming device 110 may use the advertisement's programmatic rules, images and/or sounds to, as above, place the advertisement in a currently executing electronic game environment so as to allow a player to use in-game play to reach the advertisement.

Referring to step 220 of flowchart 200 in FIG. 2 and system 100 of FIG. 1, step 220 of flowchart 200 comprises processor 111 of electronic gaming device 110 detecting when a player using electronic gaming device 110 reaches an advertisement for in-game interactive advertising.

As described previously, an advertisement for in-game interactive advertising may comprise, for example, programmatic rules, visible images and/or audible sounds that are configured to communicate an advertising message to a player within an electronic game environment.

For example, in an embodiment where an advertisement comprises a visible image, electronic gaming device 110 may be configured, by the advertisement's programmatic rules, to detect a player reaching the advertisement by determining that the advertisement lies within an angle of view of the player, such as when programmatic rules of the electronic game environment dictate that the advertisement be rendered on display 115, for example, as a result of player input provided by controller 115. Alternatively, or in addition, gaming device 110 may detect a player reaching the advertisement when the advertisement is rendered on display 115 and overlaid by a mouse cursor controlled by a player through controller 115, or the like. In another embodiment, where an advertisement comprises an audible sound, for example, electronic device 110 may detect a player reaching the advertisement by determining when an in-game position of the player is within a pre-determined perimeter surrounding the advertisement, for example, or when the player reaches a particular time of play.

As a further example, an advertisement may comprise an image and a programmatic rule that dictates rendering of the image when a player reaches a particular in-game position and is oriented within the electronic game environment so as to have a particular angle of view. Additionally, the advertisement may also comprise a programmatic rule, similar to that described above, that requires detecting a player reaching the advertisement only when a player overlays the advertisement's image with a mouse cursor using controller 115, for example. In this embodiment, once a player has reached a particular position and orientation, and after electronic gaming device 110 has rendered the advertisement's image and the player has overlaid the image with a mouse cursor, electronic gaming device 110 may then notify the player of an option to bookmark the advertisement.

In each embodiment, because an advertisement may comprise programmatic rules defining when to communicate a particular type of advertising media to a player, an advertiser may adjust an advertisement to meet specific requirements or developing needs, particularly if the advertisement is, for example, updated periodically by advertising server 130.

Referring to step 230 of flowchart 200 in FIG. 2 and system 100 of FIG. 1, step 230 of flowchart 200 comprises processor 111 of electronic gaming device 110 notifying a player using electronic gaming device 110 of an option to bookmark an advertisement. As explained previously, electronic gaming device 110 may communicate with a player through use of visible images displayed using display 115, audible sounds played using speaker 116, or through a combination of images and sounds, or through any other means, such as through physical motion generated by an electro-mechanical device, for example, situated in controller 114. As such, electronic gaming device 110 may notify a player using one or any combination of possible communication means.

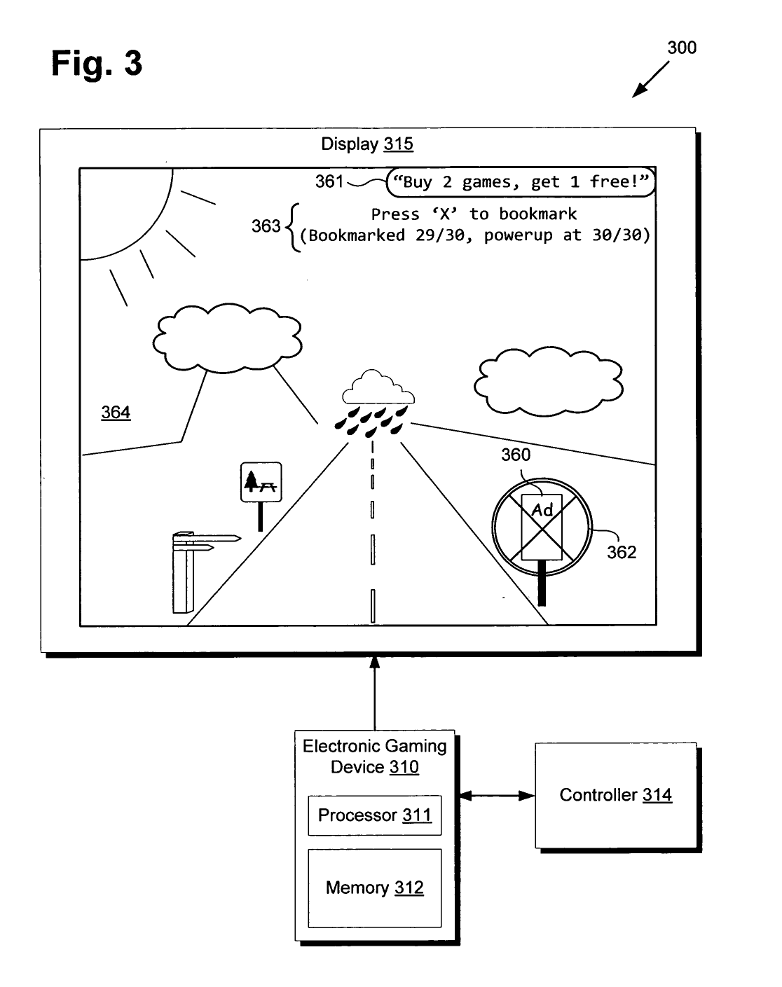

For example, notifying a player may comprise instructing a player to perform a required action to bookmark an advertisement. Such a required action may comprise, for example, a player using controller 115 to face a particular direction within an electronic game environment, for example, or a player saying a particular word or making a particular sound for sampling by microphone 117. In such case, electronic gaming device 110 may render a visible image comprising, for example, text that communicates such instruction and/or an image providing visual cues as to how to proceed to bookmark an advertisement. Alternatively, or in addition, electronic gaming device 110 may produce an audible sound comprising, for example, audible instructions or cues as to how to proceed. In another embodiment, notifying a player may comprise listing an in-game reward for choosing to bookmark the advertisement, such as increasing a player's in-game capabilities, for example, or the like. In each case, a player may or may not choose to bookmark the advertisement, and may communicate such selected option by conforming or not conforming to the terms of the notification. A more detailed example of notifying a player of an option to bookmark an advertisement is provided below with respect to FIG. 3.

Because an advertisement may comprise programmatic rules defining how to communicate a particular type of advertising media to a player, an advertiser may adjust an advertisement to meet specific requirements or developing needs, particularly if the advertisement is, for example, updated periodically by advertising server 130, as noted above.

Bookmarking an advertisement may comprise, for example, storing an electronic reference or bookmark to the advertisement in a bookmark record (e.g., an electronic file) residing in, for example, memory 112 of electronic gaming device 110, or in game server 140. As such, bookmarking an advertisement allows for later retrieval of a reference to the advertisement, which in turn allows an advertiser to communicate a more extensive advertising message to a player without unduly interrupting game play. A reference to an advertisement and the contents of a more extensive advertising message may comprise a portion of the programmatic rules, images and/or sounds of an advertisement for in-game interactive advertising, as described above, or may comprise additional content received from advertising server 130 or game server 140 after, for example, a player has opted to bookmark an advertisement.

Referring to step 240 of flowchart 200 in FIG. 2 and system 100 of FIG. 1, step 240 of flowchart 200 comprises processor 111 of electronic gaming device 110 receiving a selected option from a player. As explained above, a player may or may not choose to bookmark an advertisement, and may communicate such selected option by conforming or not conforming to terms of a notification. For example, after reaching an advertisement, a player may be notified by electronic gaming device 110 that the player must say the phrase “bookmark this ad” in order to receive additional in-game health, or to continue on a particular in-game path or quest. A player may then continue playing the game without saying the phrase, thereby opting not to bookmark the advertisement, and electronic gaming device 110 may, according to programmatic rules in the advertisement, for example, determine that the option has not been chosen, thus receiving the selected option from the player. Similar to the steps described above, because the receiving of the selected option may happen seamlessly within the execution of the electronic game environment, this step may advantageously be performed without unduly interrupting game play.

Referring to step 250 of flowchart 200 in FIG. 2 and system 100 of FIG. 1, step 250 of flowchart 200 comprises processor 111 of electronic gaming device 110 storing a selected option in a bookmark record. As explained previously, a selected option may comprise a choice to bookmark or to not bookmark a particular advertisement. Storing such a selected option may comprise, for example, storing a time and date when a player was notified of a particular advertisement, storing a length of time it took a player to choose whether to bookmark an advertisement, or may comprise simply storing or bookmarking an advertisement. In addition, storing such a selected option may also comprise storing any circumstances, such as time, date or duration for example, associated with, for instance, receiving an advertisement from advertising server 130, placing an advertisement in an electronic game environment, detecting when a player reaches an advertisement, notifying a player of an option to bookmark an advertisement, storing a selected option, or any combination of the above. As above, because the storing of the selected option may happen seamlessly within the execution of the electronic game environment, this step may advantageously be performed without unduly interrupting game play.

By storing a selected option in a bookmark record, an embodiment of the present invention provides a means for an advertiser to communicate to a player of an electronic game multiple times without unduly inconveniencing the player with interruptions in game play. For example, an advertiser may unobtrusively communicate an advertising message once during game play utilizing the advertisement itself and, in some embodiments, the notifying mechanism described above. If a player opts to bookmark an advertisement, an advertiser is provided the opportunity to communicate a second time to the player when, for example, the player later accesses a bookmark record.

For example, in a further embodiment of the present invention, electronic device 110 may communicate a portion of a bookmark record to a player upon the player leaving an electronic gaming environment. Such portion may comprise simply an electronic reference to the advertisement, or may comprise a hypertext link that may be used to download and explore a more extensive advertising message, such as a marketing video or a printable coupon, for example. In other embodiments, such portion may already comprise additional advertising content without requiring the use of a hypertext link. In yet another embodiment, electronic device 110 may communicate a bookmark in the bookmark record, corresponding to a previously selected option, to a player when the player leaves the electronic game environment, and then additionally list an in-game reward for the player if the player chooses to follow the bookmark. Thus, as can be seen, by providing a means to bookmark an advertisement, embodiments of the present invention provide a beneficially easy way for a player to retrieve and access a desired advertising experience when, for example, leaving game play. In related manner, by providing a means to communicate multiple times with a player, embodiments of the present invention provide a variety of ways to increase the efficacy of in-game advertising.

In addition to the above advantages, however, where storing a selected option includes storing other circumstances associated with the in-game advertising, as outlined above, an advertiser may have access to additional information with which to better tailor a particular advertisement for a particular audience or electronic game environment.

For example, further embodiments of the present invention may include steps such as transmitting a portion of a bookmark record to, for example, advertising server 130 or game server 140 over network 120 using network interface 119. In such cases, an advertiser may access the portion of the bookmark record and note, for example, that certain advertisements are never bookmarked. Using such information, an advertiser may develop new advertisements that are, for example, placed differently in an electronic game environment, or comprise different programmatic rules, images and/or sounds in order to increase a rate of bookmarking.

For instance, an advertiser may choose to include in a notification displayed by display 115 when a player reaches a particular advertisement that a player who opts to bookmark the advertisement gets an in-game reward and an additional discount off an advertised item, relative to, for example, a previously placed advertisement. By providing a means for this granularity of control, embodiments of the present invention provide an increased incentive for advertisers to use electronic game environments for their advertising medium, thus providing increased funding for interactive electronic games. Moreover, by structuring such in-game interactive advertising to be as unobtrusive to game play as possible, embodiments of the present invention provide for in-game interactive advertising that does not drive players away due to undesirable interruption of their in-game experience.

Moving now to FIG. 3, FIG. 3 illustrates a system 300 providing in-game interactive advertising, according to one embodiment of the present invention. System 300 of FIG. 3 includes electronic gaming device 310, controller 314 and display 315. Electronic gaming device 310 includes device processor 311 and device memory 312. Electronic gaming device 310, device processor 311, device memory 312, controller 314 and display 315 in FIG. 3 correspond respectively to electronic gaming device 110, device processor 111, device memory 112, controller 114 and display 115 in FIG. 1. As such, each corresponding structure may be configured to exhibit the same features and/or operate substantially the same as its counterpart. Also shown in FIG. 3 are roadside sign 360, text bubble 361, crosshairs 362 and text 363 displayed in electronic gaming environment 364 by electronic gaming device 310 using display 315.

In the embodiment shown in FIG. 3, an advertisement for in-game interactive advertising comprises two associated visible images, roadside sign 360 and text bubble 361, which have been placed in electronic gaming environment 364 and rendered by electronic gaming device 310 according to programmatic rules of the advertisement. For example, the advertisement's programmatic rules may dictate that roadside sign 360 is rendered using display 315 when a player turns onto the road depicted in electronic game environment 364. By tightly tying rendering of roadside sign 360 to the programmatic rules that dictate rendering of the road in electronic game environment 364, roadside sign 360 is able to convey its advertising message without unduly intruding upon game play by becoming part of the game. Text bubble 361, on the other hand, may be rendered, for example, only when crosshairs 362 guided by controller 314 overlay roadside sign 360, as shown in FIG. 3. Thus, although text bubble 361 is slightly more obtrusive than roadside sign 360, any detrimental effect to game play is limited to cases where a player's attention is already drawn to roadside sign 360.

As can be seen from FIG. 3, processor 311 of electronic gaming device 310 has determined that a player has reached either or both roadside sign 360 or text bubble 361 and is notifying the player of an option to bookmark the associated advertisement using notification 363. For example, notification 363 may have been rendered as text using display 315 when roadside sign 360 was first rendered, or notification 363 may have been rendered only after bubble text 361 was rendered. In this embodiment, notification 363 both instructs a player how to bookmark the advertisement and lists an in-game reward for opting to bookmark the advertisement. By doing so, notification 363 provides an incentive for the player to bookmark the advertisement while bringing the advertisement to the player's attention, thereby increasing a chance of generating advertising revenue from the in-game advertising.

Thus, as explained above, embodiments of the present invention provide a means for bookmarking an advertisement that benefits an advertiser by providing a separate chance at communicating an advertising message to a player, and, as a result, benefits the player by providing increased funding for interactive games without unduly intruding upon game play. Furthermore, bookmarking the advertisement also benefits the player by providing a means for the player to easily access desired advertisements at a later time.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for execution by a processor of an electronic gaming device to provide in-game interactive advertising, the method comprising:
placing an advertisment within an electronic game environment configured for execution by the electronic gaming device;
detecting when a player reaches the advertisement;
notifying the player of an option to bookmark the advertisement;
receiving a selected option from the player; and
storing the selected option in a bookmark record.

2. The method of claim 1, wherein the detecting comprises determining whether the advertisement lies within an angle of view of the player.

3. The method of claim 1, wherein the detecting comprises determining whether an in-game position of the player is within a pre-determined perimeter surrounding the advertisement.

4. The method of claim 1, wherein the notifying comprises rendering a visible image.

5. The method of claim 1, wherein the notifying comprises producing an audible sound.

6. The method of claim 1, wherein the notifying comprises instructing the player to perform a required action to bookmark the advertisement.

7. The method of claim 1, wherein the notifying comprises listing an in-game reward for choosing to bookmark the advertisement.

8. The method of claim 1, further comprising communicating a portion of the bookmark record to the player upon the player leaving the electronic game environment.

9. The method of claim 1, further comprising:
communicating a bookmark in the bookmark record corresponding to the selected option to the player upon the player leaving the electronic game environment; and
listing an in-game reward for choosing to follow the bookmark.

10. The method of claim 1, further comprising receiving the advertisment from an advertising server before placing it within the electronic game environment.

11. The method of claim 1, further comprising transmitting a portion of the bookmark record to an advertising server.

12. The method of claim 1, wherein the storing the selected option comprises bookmarking an advertisement.

13. The method of claim 1, wherein the storing the selected option comprises storing a time, date or duration associated with receiving the advertisement from an advertising server, the placing the advertisement within the electronic game environment, the detecting when the player reaches the advertisement, the notifying the player of the option to bookmark the advertisement, or the storing the selected option.

14. An electronic gaming device for providing in-game interactive advertising, comprising:
a processor configured to:
place an advertisment within an electronic game environment configured for execution by the electronic gaming device;
detect when a player reaches the advertisement;
notify the player of an option to bookmark the advertisement;
receive a selected option from the player; and
store the selected option in a bookmark record.

15. The electronic gaming device of claim 14, wherein the advertisment comprises a visible image.

16. The electronic gaming device of claim 14, wherein the advertisment comprises an audible sound.

17. The electronic gaming device of claim 14, wherein the electronic game environment comprises an augmented reality environment.

18. The electronic gaming device of claim 14, further comprising a network interface configured to request and receive the advertisment from an advertising server before placing it within the electronic game environment.

19. The electronic gaming device of claim 14, further comprising a network interface configured to transmit a portion of the bookmark record to an advertising server.

20. The electronic gaming device of claim 14, wherein the processor is further configured to communicate a portion of the bookmark record to the player upon the player leaving the electronic game environment.
